(19) United States
(12) Patent Application Publication
(10) Pub. No.: US 2025/0219681 A1
(43) Pub. Date: Jul. 3, 2025

(54) INTELLIGENT REFLECTING SURFACE

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP); Hiromi MATSUNO, Fujimino-shi (JP); Takuya OHTO, Fujimino-shi (JP); Yoshiaki AMANO, Fujimino-shi (JP)

(73) Assignee: Japan Display Inc., Tokyo (JP)

(21) Appl. No.: 19/087,658

(22) Filed: Mar. 24, 2025

Related U.S. Application Data
(63) Continuation of application No. PCT/JP2023/028261, filed on Aug. 2, 2023.

(30) Foreign Application Priority Data
Sep. 28, 2022 (JP) 2022-155057

(51) Int. Cl. H04B 7/04; H01Q 15/14; H01Q 21/06

(52) U.S. Cl. CPC H04B 7/04013; H01Q 15/14; H01Q 21/065

(57) ABSTRACT

An intelligent reflecting surface includes a plurality of first patch electrodes, a plurality of second patch electrodes including a size different from the plurality of first patch electrodes, a ground electrode facing and spaced apart from the plurality of first patch electrodes and the plurality of second patch electrodes, and a liquid crystal layer provided between the plurality of first patch electrodes, the plurality of second patch electrodes, and the ground electrode. In a plan view, the plurality of first patch electrodes and the plurality of second patch electrodes are arranged in a first a second directions. In the case where a distance between centers of two adjacent first patch electrodes is a distance W1, the second patch electrode is arranged at a position spaced apart from the first patch electrode by a distance W1/2 parallel to the first direction and a distance W1/2 parallel to the second direction.

### CROSS-REFERENCE TO RELATED APPLICATIONS

This application is a Continuation of International Patent Application No. PCT/JP2023/028261, filed on Aug. 2, 2023, which claims the benefit of priority to Japanese Patent Application No. 2022-155057, filed on Sep. 28, 2022, the entire contents of which are incorporated herein by reference.

### FIELD

An embodiment of the present invention relates to an intelligent reflecting surface (a radio wave reflecting device) to be able to control a traveling direction of reflected radio waves.

### BACKGROUND

A phased array antenna (Phased Array Antenna) device includes a plurality of antenna elements arranged in a plane. In the phased array antenna device, an amplitude and a phase of a high-frequency signal applied to each of the plurality of antenna elements are adjusted. As a result, the phased array antenna device can control directivity of the antenna in a state in which each of the plurality of antenna elements is fixed.

In order to adjust the amplitude and the phase of the high-frequency signal applied to each of the plurality of antenna elements, the phased array antenna device requires a phase shifter. For example, the phased array antenna device using a phase shifter that utilizes a change in a dielectric constant due to an alignment state of a liquid crystal is known.

For example, the antenna element of the phased array antenna device includes a plurality of strip wirings, a planar electrode opposed to the plurality of strip wirings, and a liquid crystal layer arranged between the plurality of strip wirings and the planar electrode. For example, different voltages are applied to the plurality of strip wirings. As a result, reflected waves generated on the basis of an alignment of a liquid crystal of the liquid crystal layer being adjusted for each antenna element can be superimposed, so that a phase of radio waves can be changed. Thus, a reflection direction of the radio wave can be set to an arbitrary direction.

### SUMMARY

An intelligent reflecting surface includes a plurality of first patch electrodes, a plurality of second patch electrodes having a size different from that of the plurality of first patch electrodes, a ground electrode facing the plurality of first patch electrodes and the plurality of second patch electrodes and spaced apart from the plurality of first patch electrodes and the plurality of second patch electrodes, and a liquid crystal layer arranged between the plurality of first patch electrodes and the plurality of second patch electrodes and the ground electrode, wherein the plurality of first patch electrodes and the plurality of second patch electrodes are arranged in a matrix in a first direction and a second direction intersecting the first direction in a plan view, and in the case where a distance between centers of two adjacent first patch electrodes is a distance W1, the second patch electrode is arranged at a position spaced apart from the first patch electrode by a distance W1/2 in parallel with the first direction and a distance W1/2 in parallel with the second direction, based on a position of the first patch electrode.

### BRIEF DESCRIPTION OF DRAWINGS

FIG. 1 is a plan view showing a reflector unit cell used in a radio wave reflecting device according to a first embodiment of the present invention.

FIG. 2 is a cross-sectional view showing a cross-sectional surface of a line A1-A2 shown in FIG. 1.

FIG. 3 is a cross-sectional view showing a cross-sectional surface of a line B1-B2 shown in FIG. 1.

FIG. 4 is a cross-sectional view showing a cross-sectional surface of a line C1-C2 or a cross-sectional view showing a cross-sectional surface of a line C3-C4 shown in FIG. 1.

FIG. 5 is a diagram for explaining a first sub-unit cell included in the reflector unit cell according to the first embodiment of the present invention.

FIG. 6 is a diagram for explaining a second sub-unit cell included in the reflector unit cell according to the first embodiment of the present invention.

FIG. 7 is a diagram showing a state in which no voltage is applied between a patch electrode and a ground electrode in the reflector unit cell used in the radio wave reflecting device according to the first embodiment of the present invention.

FIG. 8 is a diagram showing a state in which a voltage is applied between the patch electrode and the ground electrode in the reflector unit cell used in the radio wave reflecting device according to the first embodiment of the present invention.

FIG. 9 is a diagram schematically showing that a direction of a reflected wave is changed by the radio wave reflecting device according to the first embodiment of the present invention.

FIG. 10 is a plan view showing a configuration of the radio wave reflecting device according to the first embodiment of the present invention.

FIG. 11 is a plan view showing a configuration of the reflector unit cell shown in FIG. 10.

FIG. 12 is a cross-sectional view showing a cross-sectional surface of the reflector unit cell in the radio wave reflecting device according to the first embodiment of the present invention.

FIG. 13 shows a configuration of the radio wave reflecting device according to a second embodiment of the present invention.

FIG. 14 is a plan view showing a reflector unit cell used in the radio wave reflecting device according to the second embodiment of the present invention.

FIG. 15 is a cross-sectional view showing a cross-sectional surface of a line D1-D2 shown in FIG. 14.

FIG. 16 is a cross-sectional view showing a cross-sectional surface of a line E1-E2 shown in FIG. 14.

### DESCRIPTION OF EMBODIMENTS

In the communication field, the introduction of the fifth-generation communication standard called 5G is progressing. In this communication standard, a millimeter-wave-band frequency (26 GHz or more, e.g., 26 GHz to 29 GHz) is adopted. Communication according to the 5G standard can achieve very high-throughput by adopting a millimeter-wave-band frequency, and can be transmitted over a wide bandwidth. However, a radio wave having a frequency in a millimeter wave band has high linearity and is difficult to propagate around an obstacle. Therefore, in urban areas and the like, a communication area in which the 5G standard can be covered is narrowed.

In order to deal with such a problem, it is conceivable to change a transmission direction of radio waves by using a reflecting plate in order to widen the communication area while avoiding obstacles. However, in the phased array antenna device described in Patent Literature 1, the amount of phase change of the radio wave is not sufficient, and the radio wave cannot be reflected in a target direction.

In view of such problems, an object of an embodiment of the present invention is to improve the reflection gain of a radio wave reflecting device.

The radio wave reflector may be described as an intelligent reflecting surface. Hereinafter, the radio wave reflecting device of the present invention will be described with reference to the drawings and the like. However, the present invention can be implemented in many different aspects, and should not be construed as being limited to the description of the embodiments exemplified below. In order to make the description clearer, the drawings may be schematically represented with respect to the width, thickness, shape, and the like of each part as compared with the actual embodiment, but the drawings are merely examples, and do not limit the interpretation of the present invention. In the present specification and the drawings, elements similar to those already described with respect to the figures already described are denoted by the same reference signs (or reference signs denoted by a, b, or the like) and detailed description thereof may be omitted as appropriate. Furthermore, the terms “first” and “second” with respect to the respective elements are convenient signs used to distinguish the respective elements, and do not have any further meaning unless otherwise specified.

As used herein, in the case where a member or region is referred to as being “above (or below)” another member or region, this includes not only a case where it is directly above (or directly below) the other member or region, but also a case where it is above (or below) the other member or region unless otherwise limited, that is, a case where another component is included between the other member or region.

In the present specification, a direction X intersects a direction Y. The direction X is referred to as a first direction, and the direction Y is referred to as a second direction.

In the present specification, in the case where the terms “same” and “corresponding” are used, the terms “same” and “corresponding” may include errors within the scope of the design.

### First Embodiment

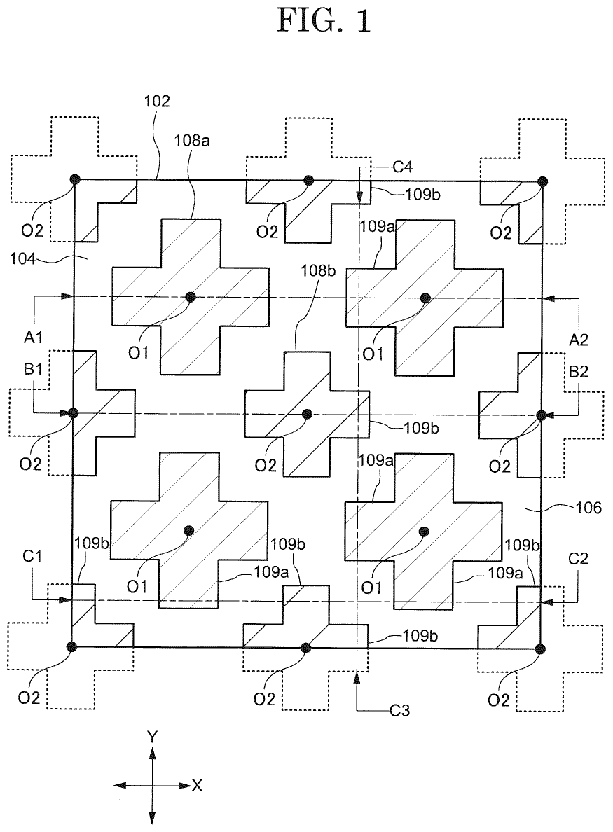

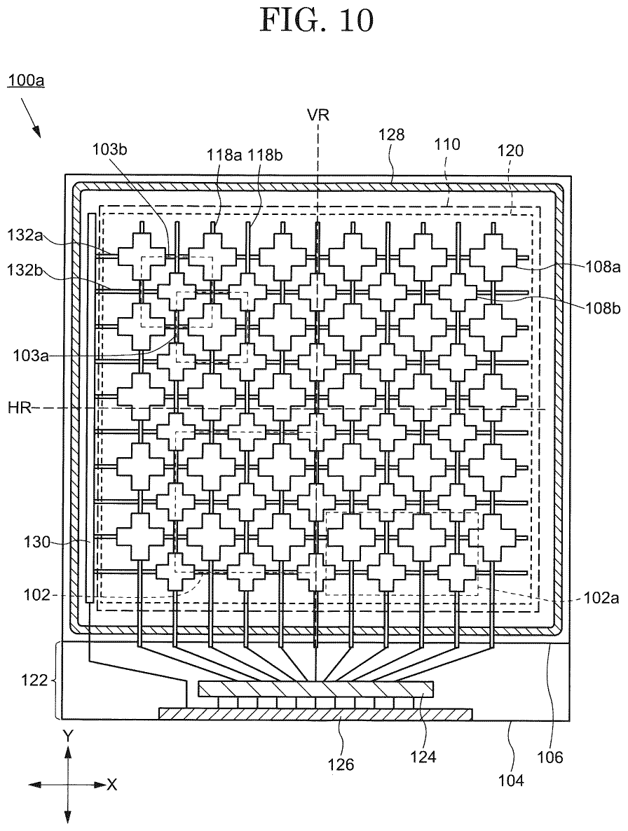

In a first embodiment, a radio wave reflecting device 100a capable of biaxial reflection control (see FIG. 10) will be described with reference to FIG. 1 to FIG. 12.

### 1. Reflector Unit Cell

First, a reflector unit cell 102 used in the radio wave reflecting device 100a according to the first embodiment will be described. The radio wave reflecting device 100a includes a plurality of reflector unit cells 102.

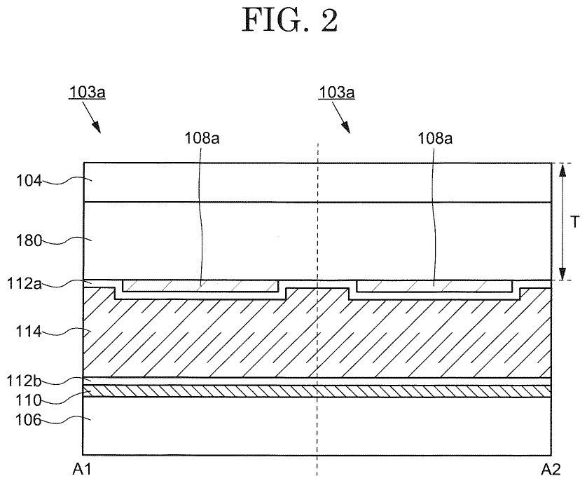

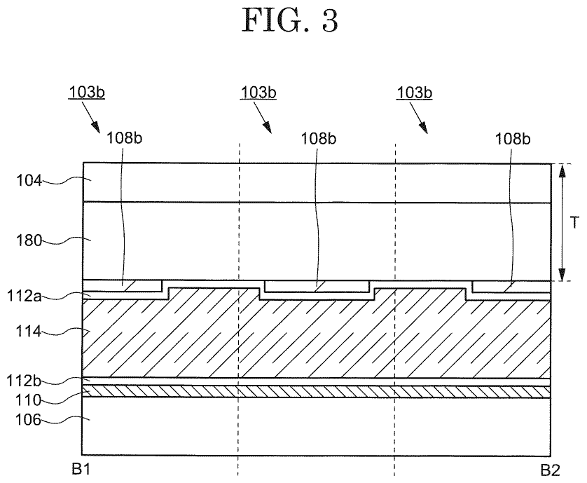

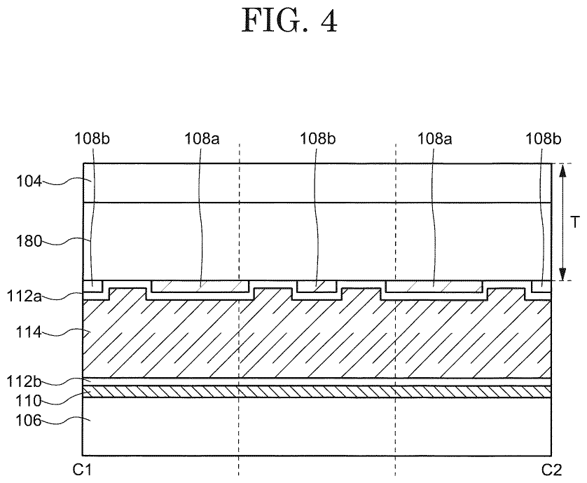

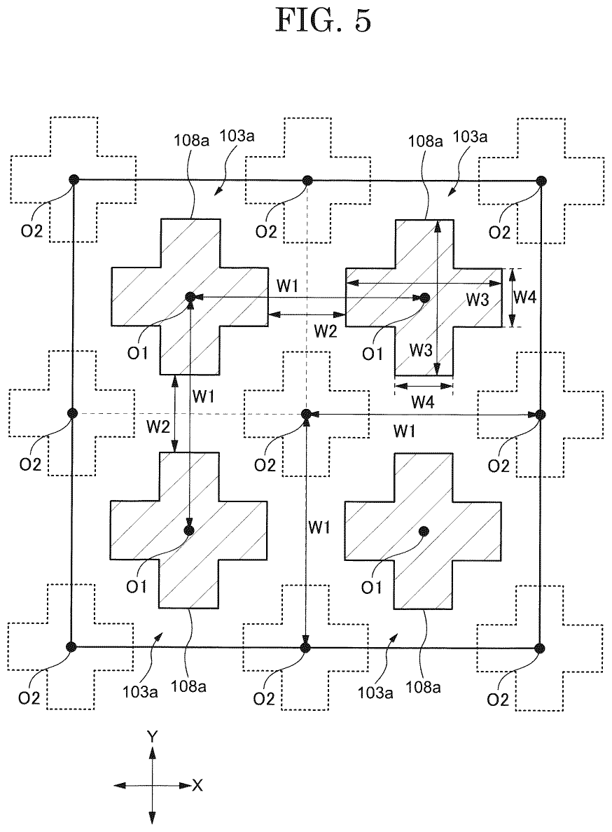

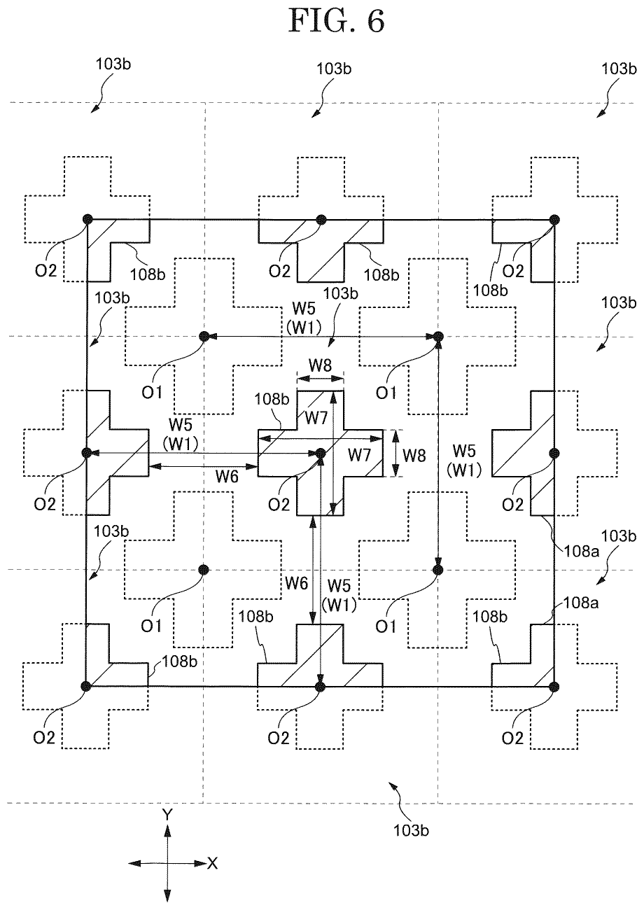

FIG. 1 is a plan view when the reflector unit cell 102 is viewed from above (a side on which radio waves are incident). FIG. 2 is a cross-sectional view showing a cross-sectional surface of a line A1-A2 shown in FIG. 1, FIG. 3 is a cross-sectional view showing a cross-sectional surface of a line B1-B2 shown in FIG. 1, and FIG. 4 is a cross-sectional view showing a cross-sectional surface of a line C1-C2 or a cross-sectional surface of a line C3-C4 shown in FIG. 1. FIG. 5 is a diagram for explaining a first sub-unit cell 103a included in the reflector unit cell 102, and FIG. 6 is a diagram for explaining a second sub-unit cell 103b included in the reflector unit cell 102.

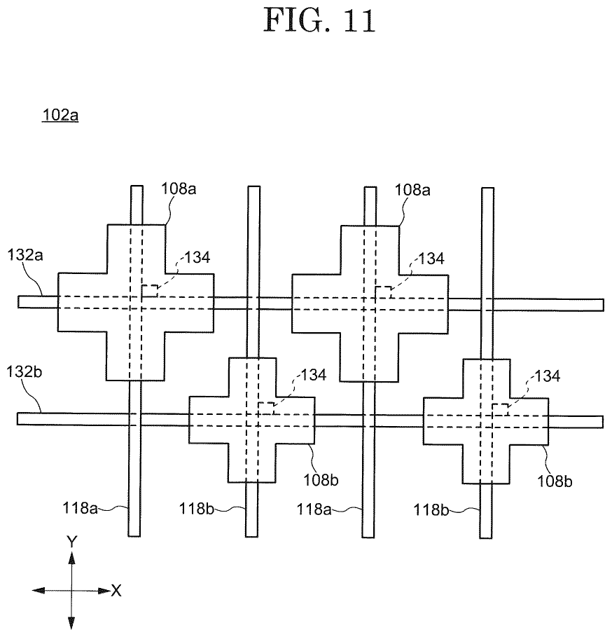

As shown in FIG. 1, FIG. 2, FIG. 3, FIG. 4, FIG. 5, or FIG. 6, the reflector unit cell 102 includes the first sub-unit cell 103a and the second sub-unit cell 103b. A portion of the first sub-unit cell 103a overlaps the second sub-unit cell 103b, and a portion of the second sub-unit cell 103b overlaps the first sub-unit cell 103a. The first sub-unit cell 103a includes an opposing substrate 106, a ground electrode 110, a second alignment film 112b, a liquid crystal layer 114, a first alignment film 112a, a patch electrode 108a, an array layer 180, and a dielectric substrate 104. The second sub-unit cell 103b includes the dielectric substrate 104, the opposing substrate 106, the ground electrode 110, the second alignment film 112b, the liquid crystal layer 114, the first alignment film 112a, a patch electrode 108b, the array layer 180, and the dielectric substrate 104. Among the first sub-unit cell 103a and the second sub-unit cell 103b, the dielectric substrate 104 may be regarded as a dielectric layer forming one layer. Thus, the dielectric substrate 104 may be referred to as a dielectric layer. As will be described further below, the array layer 180 includes switching elements 134 (see FIG. 11) electrically connected to each of the patch electrodes 108a and 108b. The patch electrode 108a may be referred to as a first patch electrode, and the patch electrode 108b may be referred to as a second patch electrode.

As shown in FIG. 2 to FIG. 4, the array layer 180 is arranged above the dielectric substrate 104. The patch electrodes 108a and 108b are arranged above the array layer 180. The first alignment film 112a is arranged so as to cover the patch electrodes 108a and 108b. The ground electrode 110 is arranged above the opposing substrate 106. The second alignment film 112b is arranged so as to cover the ground electrode 110. The patch electrodes 108a and 108b are arranged to face the ground electrode 110. The liquid crystal layer 114 is arranged between the patch electrodes 108a and 108b and the ground electrode 110. The first alignment film 112a is interposed between the patch electrodes 108a and 108b and the liquid crystal layer 114. The second alignment film 112b is interposed between the ground electrode 110 and the liquid crystal layer 114. A thickness T of the dielectric substrate 104 is, for example, a length from a surface of the patch electrode 108 on a liquid crystal layer 114 side to a surface of the dielectric substrate 104 on a side opposite to a surface on which the patch electrode 108 is provided.

For example, a difference between the first sub-unit cell 103a and the second sub-unit cell 103b in the radio wave reflecting device 100a is the sizes of the patch electrode 108a and the patch electrode 108b. In the embodiment shown in FIG. 1, the size of the patch electrode 108a is larger than the size of the patch electrode 108b. The size of the patch electrode 108a may be smaller than the size of the patch electrode 108b. In the present specification, the first sub-unit cell 103a and the second sub-unit cell 103b are simply referred to as reflector unit cells 102 in the case where they are not particularly distinguished from each other. In the case where the patch electrode 108a and the patch electrode 108b do not need to be specifically distinguished, they are simply referred to as patch electrodes 108.

As shown in FIG. 5, in a plan view of a plurality of first sub-unit cells 103a, a plurality of patch electrodes 108a is arranged in a matrix in the direction X (first direction) and the direction Y (second direction) intersecting the direction X. A distance between a center O1 of the patch electrode 108a and a center O1 of the adjacent patch electrode 108a parallel to the direction X is a distance W1. As in the direction X, a distance between the center O1 of the patch electrode 108a and the center O1 of the adjacent patch electrode 108a parallel to the direction Y is the distance W1. That is, the plurality of patch electrodes 108a is arranged at the same pitch (distance W1) in the direction X and the direction Y. In other words, the plurality of first sub-unit cells 103a is arranged at the same pitch (distance W1) in the direction X and the direction Y.

For example, a shape of the patch electrode 108a is a cross shape. A length of a pattern parallel to the direction X of the cross shape is the same as a length of the pattern parallel to the direction Y of the cross shape, and the length thereof is a length W3. A width of the pattern parallel to the direction X of the cross shape is the same as a width of the pattern parallel to the direction Y of the cross shape, and the width thereof is a width W4. A distance between the patch electrode 108a and the neighboring patch electrode 108a is a distance W2.

As shown in FIG. 6, in a plan view of a plurality of second sub-unit cells 103b, a plurality of patch electrodes 108b is arranged in a matrix in the direction X and the direction Y, similar to the plurality of patch electrodes 108a. A distance between a center O2 of the patch electrode 108b and a center O2 of the adjacent patch electrode 108b parallel to the direction X and a distance between the center O2 of the patch electrode 108b and the center O2 of the adjacent patch electrode 108a parallel to the direction Y are a distance W5. That is, the plurality of patch electrodes 108b is arranged at the same pitch (distance W5) in the direction X and the direction Y. In other words, the plurality of second sub-unit cells 103b is arranged at the same pitch (distance W5) in the direction X and the direction Y. In the present specification, the distance W5 is the same as the distance W1. That is, the second sub-unit cells 103b are arranged at the same pitch as the first sub-unit cells 103a.

For example, a shape of the patch electrode 108b is a cross shape, similar to the shape of the patch electrode 108a. In the patch electrode 108b, a length of a pattern parallel to the direction X of the cross shape is the same as a length of the pattern parallel to the direction Y of the cross shape, and the length thereof is a length W7. A width of the pattern parallel to the direction X of the cross shape is the same as a width of the pattern parallel to the direction Y of the cross shape, and the width thereof is a width W8. A distance between the patch electrode 108b and the adjacent patch electrode 108b is a distance W6.

For example, the distance W1 is the same as the distance W5, the distance W2 is shorter than the distance W6, the width W3 is longer than the length W7, and the width W4 is longer than the width W8.

The cross shape is a shape having four-fold rotational symmetry with respect to each of the center O1 of the patch electrode 108a and the center O2 of the patch electrode 108b. Since the patch electrode 108a has rotational symmetry with respect to the center O1 of the patch electrode 108a, anisotropy with respect to reflectance of the radio wave can be reduced with respect to a vertically polarized wave and a horizontally polarized wave of an incoming radio wave. Similar to the patch electrode 108a, the patch electrode 108b has rotational symmetry with respect to the center O2 of the patch electrode 108b, so that anisotropy with respect to reflectance of the radio wave can be reduced with respect to a vertically polarized wave and a horizontally polarized wave of an incoming radio wave. That is, polarization of the vertically polarized wave and the horizontally polarized wave in an XY plane in FIG. 1, FIG. 5, and FIG. 6 can be suppressed, and the vertically polarized wave and the horizontally polarized wave can be uniformly reflected.

As shown in FIG. 1, FIG. 5, and FIG. 6, in a plan view of the radio wave reflecting device 100a, the plurality of patch electrodes 108a and the plurality of patch electrodes 108b are arranged in a houndstooth check pattern (hounds tooth check pattern) or a checkered pattern (Checkered pattern). Specifically, the patch electrode 108b is spaced apart from the patch electrode 108a by a distance W1/2 (W5/2) parallel to the direction X and the distance W1/2 (W5/2) parallel to the direction Y. In a square formed by connecting centers O2 of four patch electrodes 108b surrounding one patch electrode 108a with lines, an intersection of diagonal lines of the square coincides with a center O1 of the one patch electrode 108a. Similarly, in a square formed by connecting centers O1 of four patch electrodes 108a around one patch electrode 108b with lines, an intersection of diagonal lines of the square coincides with a center O2 of the one patch electrode 108b.

In the radio wave reflecting device 100a, for example, although a shape of the plurality of patch electrodes 108a and a shape of the plurality of patch electrodes 108b are cross-shaped, the shape of the plurality of patch electrodes 108a and the shape of the plurality of patch electrodes 108b are not limited to cross-shaped. For example, the shape of the patch electrode 108a and the shape of the patch electrode 108b may be a polygon obtained by rotating a square having the same length in the direction X and the direction Y by 45 degrees, or may be a diamond having four-fold rotational symmetry with respect to the patch electrode 108a and a diamond having four-fold rotational symmetry with respect to the center O2 of the patch electrode 108b.

A shape of the ground electrode 110 is not limited. For example, the shape of the ground electrode 110 may be a shape having an area larger than that of the patch electrode 108a. In the radio wave reflecting device 100a, the ground electrode 110 is provided on the entire surface or substantially the entire surface of the opposing substrate 106 on which the liquid crystal layers 114 are arranged.

A material for forming the patch electrode 108 and the ground electrode 110 is not limited. For example, the patch electrode 108 and the ground electrode 110 are formed using a conductive metal or a metal oxide.

Although described in detail later, the dielectric substrate 104 may be provided with first wirings 118a and 118b. For example, the first wiring 118a connects the patch electrodes 108a arranged in the same column, and the first wiring 118b connects the patch electrodes 108b arranged in the same column. The first wirings 118a and 118b may be used when applying a control signal to the patch electrode 108a and the patch electrode 108b. The first wirings 118a and 118b may be used to connect the patch electrode 108a and the patch electrode 108b.

The reflector unit cell 102 is used as a reflector 120 that reflects radio waves in a predetermined direction. Therefore, it is preferable that the amplitude of the reflected radio wave of the reflector unit cell 102 is not attenuated as much as possible. As is apparent from the structures shown in FIG. 2 to FIG. 4, when radio waves propagating in the air are reflected by the reflector unit cell 102, the radio waves pass through the dielectric substrate 104 twice. The dielectric substrate 104 is preferably formed of, for example, a dielectric material such as glass or resin.

The dielectric substrate 104 is bonded to the opposing substrate 106 using a sealing material 128 (see FIG. 10). The dielectric substrate 104 is arranged to face the opposing substrate 106 so that a gap is included between the dielectric substrate 104 and the opposing substrate 106. The liquid crystal layer 114 is arranged in a region surrounded by the sealing material 128. In a side view, the gap between the dielectric substrate 104 and the opposing substrate 106 is 20 μm or more and 100 μm or less. In the radio wave reflecting device 100a, the gap between the dielectric substrate 104 and the opposing substrate 106 is, for example, 75 μm. The patch electrode 108, the ground electrode 110, the first alignment film 112a, and the second alignment film 112b are provided between the dielectric substrate 104 and the opposing substrate 106. Specifically, a gap between the first alignment film 112a and the second alignment film 112b provided on each of the dielectric substrate 104 and the opposing substrate 106 is a thickness of the liquid crystal layer 114. Although not shown, spacers may be provided between the dielectric substrate 104 and the opposing substrate 106 to keep an interval constant.

A control signal for controlling an alignment of liquid crystal molecules of the liquid crystal layer 114 is applied to the patch electrode 108. The control signal is a DC voltage signal or a polarity inversion signal in which a positive DC voltage and a negative DC voltage are alternately inverted. A voltage of an intermediate level of a ground or polarity inversion signal is applied to the ground electrode 110. By applying the control signal to the patch electrode 108, an alignment state of the liquid crystal molecules contained in the liquid crystal layer 114 is changed. A liquid crystal material having dielectric anisotropy is used for the liquid crystal layer 114. For example, a nematic liquid crystal, a smectic liquid crystal, a cholesteric liquid crystal, or a discotic liquid crystal is used as the liquid crystal layer 114. In the liquid crystal layer 114 having dielectric anisotropy, a dielectric constant changes due to the change in the alignment state of the liquid crystal molecules. The reflector unit cell 102 can change the dielectric constant of the liquid crystal layer 114 by the control signal applied to the patch electrode 108. Thus, when the radio wave is reflected, a phase of the reflected wave can be delayed.

Frequency bands of the radio waves reflected by the reflector unit cell 102 are a very high frequency (VHF: Very High Frequency) band, an ultra-high frequency (UHF: Ultra-High Frequency) band, a microwave (SHF: Super High Frequency) band, a sub-millimeter wave (THF: Tremendously high frequency), and a millimeter wave (EHF: Extra High Frequency) band. The millimeter wave refers to, for example, a frequency band of 30 GHz to 300 GHz. A frequency band of a fifth-generation communication standard called 5G includes a 26 GHz band to a 29 GHz band. For example, frequencies above 26 GHz band may be collectively referred to as millimeter waves. Alignment of the liquid crystal molecules in the liquid crystal layer 114 changes in response to a control signal applied to the patch electrode 108, but hardly follows the frequency of the radio wave incident on the patch electrode 108. Therefore, the reflector unit cell 102 can control the phase of the radio wave reflected without being affected by the radio wave.

The plurality of patch electrodes 108a and the plurality of patch electrodes 108b are electrodes capable of reflecting frequencies of radio waves corresponding to the 5G communication standard. For example, as described above, the frequency may be a frequency in the millimeter wave band, may be a frequency of 26 GHz or more, and may be a frequency of 36 GHz or more.

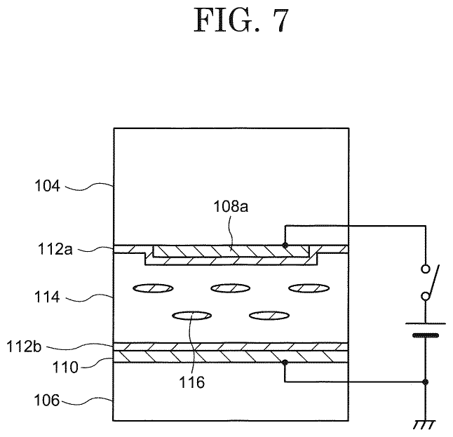

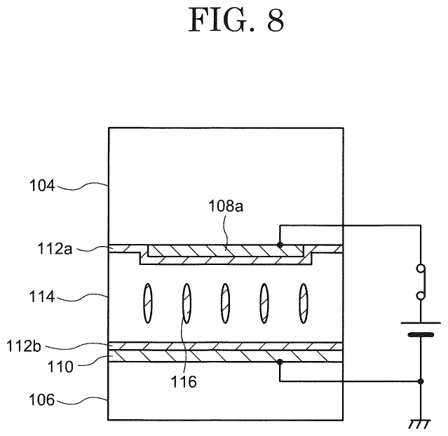

FIG. 7 shows a state in which no voltage is applied between the patch electrode 108 and the ground electrode 110 (referred to as a “first state”). FIG. 7 shows a case where the first alignment film 112a and the second alignment film 112b are horizontally aligned films. The long axes of liquid crystal molecules 116 in the first state are aligned horizontally with respect to surfaces of the patch electrode 108 and the ground electrode 110 by the first alignment film 112a and the second alignment film 112b. FIG. 8 shows a state in which the control signal (voltage signal) is applied to the patch electrode 108 (referred to as a “second state”). In the second state, the liquid crystal molecules 116 are subjected to an electric field so that their long axes are oriented perpendicularly to the surfaces of the patch electrode 108 and the ground electrode 110. An angle at which the long axes of the liquid crystal molecules 116 are aligned can also be aligned in a direction intermediate between the horizontal direction and the vertical direction depending on the magnitude of the control signal applied to the patch electrode 108 (magnitude of the voltage between the ground electrode and the patch electrode).

In the case where the liquid crystal molecules 116 have positive dielectric anisotropy, the dielectric constant of the second state is larger than that of the first state. In the case where the liquid crystal molecules 116 have negative dielectric anisotropy, the apparent dielectric constant of the second state is smaller than that of the first state. The liquid crystal layer 114 having dielectric anisotropy can also be regarded as a variable dielectric layer. The reflector unit cell 102 may be controlled to delay (or not delay) the phase of the reflected wave by utilizing the dielectric anisotropy of the liquid crystal layer 114.

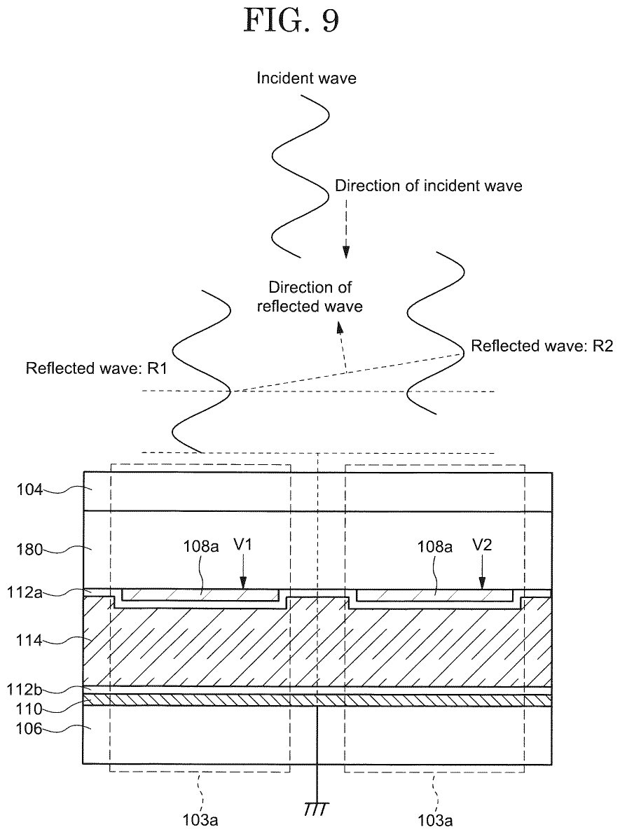

FIG. 9 schematically shows that the direction of the reflected wave is changed by any first sub-unit cell 103a and the first sub-unit cell 103a adjacent to any first sub-unit cell 103a. Any first sub-unit cell 103a and the first sub-unit cell 103a adjacent to any first sub-unit cell 103a are adjacent in the direction X. That is, any patch electrode 108a and the patch electrode 108a adjacent to adjoining any patch electrode 108a are connected to different first wirings 118 (the first wiring 118a and the first wiring 118b). In the case where radio waves enter any first sub-unit cell 103a and the adjacent first sub-unit cell 103a in the same phase, since different control signals (V1≠V2) are applied to any first sub-unit cell 103a and the adjacent first sub-unit cell, a phase change of the reflected wave by any first sub-unit cell 103a is larger than a phase change of the reflected wave by the adjacent first sub-unit cell 103a. Consequently, a phase of a reflected wave R1 reflected by any first sub-unit cell 103a is different from a phase of a reflected wave R2 reflected by the adjacent first sub-unit cell 103a (in FIG. 9, the phase of the reflected wave R2 leads the phase of the reflected wave R1), and apparently, the direction of the reflected wave is changed in an oblique direction. In the radio wave reflecting device 100a, in the case where the first wirings are distinguished, the first wirings are represented as the first wiring 118a and the first wiring 118b, and in the case where the first wirings are not distinguished, the first wirings are represented as the first wirings 118.

Next, in the radio wave reflecting device 100a, a thickness of the liquid crystal layer is set to 75 μm, and the phase change (deg) is simulated using the patch electrodes 108a and 108b described above. In the simulation, a reflector in which the patch electrodes 108a and 108b are arranged as shown in FIG. 1 was assumed, and the simulation was performed using a CST Studio Suite (manufactured by Dassault Systems Co., Ltd.).

Although not shown, in the radio wave reflecting device 100a, as an example, when the frequency of the radio wave is 31 GHz and the phase in a state where no voltage is applied to the liquid crystal layer is used as a reference, it has been shown that the phase change in a state where a voltage is applied to the liquid crystal layer becomes −416 deg. On the other hand, as a comparative example, it was shown that the same simulation as in the radio wave reflecting device 100a was carried out using a radio wave reflecting device including one type of patch electrode having a square shape, and as a result, the phase change amount becomes −270 deg. That is, the use of the cross-shaped patch electrodes 108a and 108b having different sizes, such as the radio wave reflecting device 100a, is effective in increasing the phase change amount. Although not shown in the drawings, for example, resonance occurring in the patch electrode 108a and resonance occurring in the patch electrode 108b can make two peaks (points at which the reflectance is minimized) of resonance frequency in the millimeter wave band by using the patch electrodes 108a and 108b having cross shapes of different sizes, so that attenuation of the amplitude of the reflected wave can be suppressed and the phase change can be increased.

As shown in FIG. 1, FIG. 5, and FIG. 6, in the radio wave reflecting device 100a, it is possible to dispose the patch electrode 108b having a size smaller than that of the patch electrode 108a at a position spaced apart by the distance W1/2 from the reference position in the direction X and the direction Y with respect to the position where the patch electrode 108a is arranged by using the patch electrodes 108a and 108b having cross shapes of different sizes. Consequently, as shown in FIG. 1, along the line C1-C2 parallel to the direction X, a cross-shaped convex portion 109a of the patch electrode 108a and a cross-shaped convex portion 109b of the patch electrode 108b can be alternately arranged, and along the line C3-C4 parallel to the direction Y, the cross-shaped convex portion 109a of the patch electrode 108a and the cross-shaped convex portion 109b of the patch electrode 108b can be alternately arranged. Therefore, in the radio wave reflecting device 100a, the density of the patch electrode in the reflector 120 (occupancy of the patch electrode in the reflector 120, a ratio of the region in which the patch electrode is provided in the reflector 120 and the region in which the patch electrode is not provided) can be increased as compared with the case where one type of patch electrode having a square shape as in the comparative example is provided. An area of the electrodes that can reflect radio waves is increased, so that the reflected strength of the radio waves can be increased by using the cross-shaped patch electrodes 108a and 108b having different sizes.

Further, as shown in FIG. 1, FIG. 5, and FIG. 6, the plurality of patch electrodes 108a and the plurality of patch electrodes 108b are arranged adjacently. With respect to a center of the reflector unit cell 102 (the center O2 of the patch electrode 108b arranged in the center in FIG. 1, FIG. 5, and FIG. 6), it is preferable that the plurality of patch electrodes 108a and the plurality of patch electrode 108b are arranged so as to have two-fold rotational symmetry or four-fold rotational symmetry. The plurality of patch electrodes 108a and the plurality of patch electrode 108b are arranged so as to have two-fold rotational symmetry or four-fold rotational symmetry, so that they can be symmetric with respect to the vertically polarized wave and the horizontally polarized wave.

As an example, although the example in which the reflector unit cell 102 of the radio wave reflecting device 100a includes two types of patch electrodes of the patch electrode 108a and the patch electrode 108b has been described, the patch electrodes are not limited to two types. The reflector unit cell 102 may include a third patch electrode (not shown) that differs from the patch electrode 108a and the patch electrode 108b. Here, a size of the third patch electrode differs from the size of the patch electrode 108a and the size of the patch electrode 108b. For example, the size of the third patch electrode may be smaller than the size of the patch electrode 108a, or may be larger than the size of the patch electrode 108b, and smaller than the size of the patch electrode 108a. The third patch electrode may be arranged between the configuration of the patch electrode 108a and the patch electrode 108b. In the case where the radio wave reflecting device 100a includes the third patch electrode, the size and arrangement of the third patch electrode are appropriately adjusted according to the sizes and arrangements of the patch electrode 108a and the patch electrode 108b, and the like, so that a radio wave reflecting device according to an embodiment of the present disclosure is configured.

As described above, at least two types of patch electrodes of the reflector unit cell 102 are set, in the radio wave reflecting device 100a. The use of the radio wave reflecting device 100a according to the first embodiment of the present disclosure is effective in suppressing the attenuation of the amplitude of the reflected wave, improving the phase change, and increasing the reflection strength of the radio wave. By using the radio wave reflecting device 100a, even in the case where a transmission path is formed in the air by combining a plurality of radio wave reflecting devices 100a, it is possible to suppress the attenuation of the radio wave, so that a communication device can perform good communication.

The patch electrode 108 and the ground electrode 110 are formed using a transparent conductive film, and the liquid crystal layer 114 has a light-transmitting property, in the radio wave reflecting device 100a. As a result, the radio wave can be reflected without impairing a daylighting property. Therefore, the radio wave reflecting device 100a can be installed in windows of high-rise architectures such as buildings. As a result, it is possible to reflect a radio wave with a high degree of straightness in a predetermined direction at a high place with relatively few obstacles. Therefore, the radio wave reflecting device 100a can be used in order to eliminate a dead zone of radio waves (a place where radio waves do not reach) in the urban area.

### 2. Radio Wave Reflecting Device

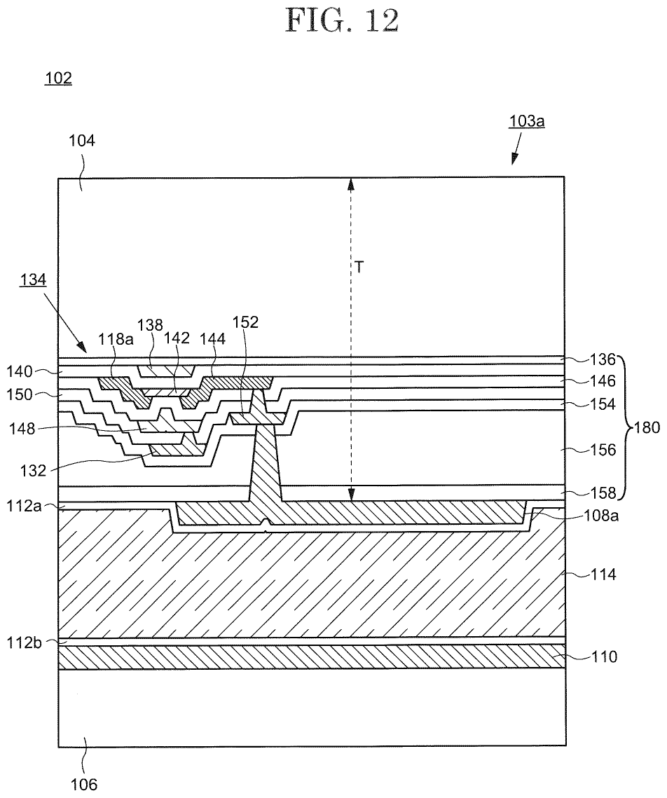

Next, a configuration of the radio wave reflecting device 100a in which the reflector unit cells 102 are integrated will be described. The radio wave reflecting device 100a is a radio wave reflecting device capable of performing biaxial reflection control. FIG. 10 is a plan view showing the configuration of the radio wave reflecting device 100a. FIG. 11 is a plan view showing the structure of the reflector unit cell 102 by enlarging the reflector unit cell 102 shown in FIG. 10. FIG. 12 is a cross-sectional view showing a cross-sectional surface of the reflector unit cell 102. Descriptions of the same or similar configurations as those in FIG. 1 to FIG. 9 will be omitted.

As described in “1. Reflector Unit Cell”, the reflector 120 is arranged between the dielectric substrate 104 and the opposing substrate 106. As shown in FIG. 10, the reflector 120 has a structure in which the plurality of reflector unit cells 102 are integrated. The reflector unit cell 102 includes the first sub-unit cell 103a and the second sub-unit cell 103b. For example, the plurality of reflector unit cells 102 (the plurality of first sub-unit cells 103a and the plurality of second sub-unit cells 103b) are arranged in the direction X and the direction Y. The first sub-unit cell 103a includes the ground electrode 110, the second alignment film 112b arranged above the ground electrode 110, the patch electrode 108a, the first alignment film 112a arranged above the patch electrode 108a, the array layer 180, and a liquid crystal layer (not shown) arranged between the first alignment film 112a and the second alignment film 112b. The second sub-unit cell 103b includes the ground electrode 110, the second alignment film 112b arranged above the ground electrode 110, the patch electrode 108b, the first alignment film 112a arranged above the patch electrode 108b, the array layer 180, and a liquid crystal layer (not shown) arranged between the first alignment film 112a and the second alignment film 112b. The patch electrodes 108a and 108b are arranged above the array layer 180 arranged above the dielectric substrate 104, and the ground electrodes 110 are arranged above the opposing substrate 106. The dielectric substrate 104 is bonded to the opposing substrate 106 using the sealing material 128. The liquid crystal layer is arranged in a region inside the sealing material 128.

The patch electrodes 108a and 108b in the reflector unit cell 102 are arranged so as to face an incident surface of the radio wave. The ground electrode 110 has a flat plate shape. The plurality of patch electrodes 108a and 108b are arranged in a matrix in the plane of the flat ground electrode 110 and in a region inside the sealing material 128.

As described in “1. Reflector Unit Cell”, in the plan view of the radio wave reflecting device 100a, the plurality of patch electrodes 108a and the plurality of patch electrodes 108b are arranged in the houndstooth check pattern or the checkered pattern. Specifically, the patch electrode 108b is spaced apart from the patch electrode 108a by the distance W1/2 (W5/2) parallel to the direction X and the distance W1/2 (W5/2) parallel to the direction Y. Each patch electrode 108a is adjacent to each patch electrode 108b in the direction X or the direction Y.

A plurality of first wirings 118a and a plurality of first wirings 118b extending in the direction Y are arranged on the dielectric substrate 104. The first wiring 118a and the first wiring 118b are alternately arranged in the direction X. Each of the plurality of first wirings 118a is electrically connected to the plurality of patch electrodes 108a arranged in the second direction, and each of the plurality of first wirings 118b is electrically connected to the plurality of patch electrodes 108b arranged in the second direction. The reflector 120 has a configuration in which a plurality of patch electrode arrays connected by the first wirings 118a and 118b are arranged in the direction Y.

A plurality of second wirings 132a and a plurality of second wirings 132b extending in the direction X are arranged on the dielectric substrate 104. The second wiring 132a and the second wiring 132b are alternately arranged in the direction Y. Each of the plurality of second wirings 132a is electrically connected to the plurality of patch electrodes 108a arranged in the second direction, and each of the plurality of second wirings 132b is electrically connected to the plurality of patch electrodes 108b arranged in the second direction. The reflector 120 has a configuration in which a plurality of patch electrode arrays connected by the second wiring 132a and the second wiring 132b are arranged in the direction X.

For example, a region of the dielectric substrate 104 other than a region where the reflector 120 is arranged is referred to as a peripheral region 122. The peripheral region 122 is provided with a first driving circuit 124 and a terminal portion 126. For example, the terminal portion 126 is a region forming a connection with an external circuit, and a flexible printed circuit is connected to the terminal portion 126 (not shown). A signal for controlling the first driving circuit 124 is input from the flexible printed circuit to the terminal portion 126.

The plurality of first wirings 118a and 118b arranged on the reflector 120 extend in the direction Y, extend in the peripheral region 122, and are connected to the first driving circuit 124. The first driving circuit 124 outputs control signals to the patch electrodes 108a and 108b via the first wirings 118a and 118b. The first driving circuit 124 can output the control signals of different voltage levels to each of the plurality of first wirings 118a and 118b. For example, the control signals of different voltage levels are control signals of a first voltage level and control signals of a second voltage level period.

The plurality of second wirings 132a and 132b extending in the direction X and provided on the reflector 120 extend in the direction X and are connected to a second driving circuit 130. The second driving circuit 130 outputs a scanning signal to the plurality of second wirings 132a and 132b.

FIG. 11 shows an enlarged view of the arrangement of two patch electrodes 108a and two patch electrodes 108b, a first wiring 118a and 118b, and a second wiring 132a and 132b. The switching element 134 is arranged in each of the two patch electrodes 108a and the two patch electrodes 108b. Switching (on/off) of the switching element 134 is controlled by the scanning signal applied to the second wirings 132a and 132b. In response to the scanning signal applied to the second wiring 132a, the patch electrode 108a having the switching element 134 turned on is electrically connected to the first wiring 118a, and a control signal is applied thereto. In response to the scanning signal applied to the second wiring 132b, the patch electrode 108b having the switching element 134 turned on is electrically connected to the first wiring 118b, and a control signal is applied thereto. The switching element 134 is formed of, for example, a thin film transistor. According to this configuration, the plurality of patch electrodes 108a and 108b arranged in the direction X can be selected for each row, and control signals of different voltage levels can be applied to each row.

The radio wave reflecting device 100a can control a direction of the reflected wave in a left-right direction of the drawing around a reflection axis VR parallel to the direction Y, and can also control a direction of the reflected wave in a vertical direction of the drawing around a reflection axis HR parallel to the direction X, in addition to the radio wave incident on the reflector 120. That is, the radio wave reflecting device 100a includes the reflection axis VR parallel to the direction Y and a reflection axis HR parallel to the direction X, and can control a reflection angle in a direction with the reflection axis VR as a rotation axis and a direction with the reflection axis HR as a rotation axis.

In the radio wave reflecting device 100a shown in FIG. 10, in the direction Y, the patch electrode 108a is arranged in parallel to the direction X on a side far from the first driving circuit 124, and the patch electrode 108b is arranged in parallel to the direction X on a side close to the first driving circuit 124. In the radio wave reflecting device 100a shown in FIG. 10, in the direction X, the patch electrode 108a is arranged in parallel to the direction Y on the side far from the second driving circuit 130, and the patch electrode 108b is arranged in parallel to the direction Y on the side close to the second driving circuit 130. The arrangement of the patch electrodes 108a and 108b is not limited to the arrangement shown in FIG. 10. For example, the patch electrode 108b may be arranged parallel to the direction X on a side far from the first driving circuit 124, and the patch electrode 108a may be arranged parallel to the direction X on a side close to the first driving circuit 124. The patch electrode 108b may be arranged parallel to the direction Y on a side far from the second driving circuit 130, and the patch electrode 108a may be arranged parallel to the direction Y on a side close to the second driving circuit 130. The configuration of the radio wave reflecting device 100a is not limited as long as the radio wave reflecting device 100a includes a configuration in which the reflection angle is controlled in a direction in which the reflection axis VR is the rotation axis and in a direction in which the reflection axis HR is the rotation axis.

FIG. 12 shows an example of a cross-sectional structure of the reflector unit cell 102 in which the switching element 134 is connected to the patch electrode 108. The reflector unit cell 102 includes a first sub-unit cell 103a and a second sub-unit cell 103b, and a cross-sectional surface of the first sub-unit cell 103a is similar to a cross-sectional surface of the second sub-unit cell 103b. Here, the cross-sectional surface of the first sub-unit cell 103a will be mainly described. The switching element 134 is arranged in the dielectric substrate 104. The switching element 134 is a transistor. The switching element 134 includes a structure in which a first gate electrode 138, a first gate insulating layer 140, a semiconductor layer 142, a second gate insulating layer 146, and a second gate electrode 148 are stacked. An undercoat layer 136 may be arranged between the first gate electrode 138 and the dielectric substrate 104. The first wiring 118a is arranged between the first gate insulating layer 140 and the second gate insulating layer 146. The first wiring 118a is provided so as to be in contact with the semiconductor layer 142. A first connection wiring 144 is arranged in the same conductive layer as a conductive layer forming the first wiring 118a. The first connection wiring 144 is arranged so as to be in contact with the semiconductor layer 142. The connection structure of the first wiring 118a and the first connection wiring 144 to the semiconductor layer 142 is a structure in which one wiring is connected to a source of the transistor and the other wiring is connected to a drain.

A first interlayer insulating layer 150 is provided to cover the switching element 134. The second wiring 132a is arranged on the first interlayer insulating layer 150. The second wiring 132a is connected to the second gate electrode 148 via a contact hole formed in the first interlayer insulating layer 150. Although not shown, the first gate electrode 138 and the second gate electrode 148 are electrically connected to each other in a region not overlapping the semiconductor layer 142. Above the first interlayer insulating layer 150, a second connection wiring 152 is arranged in the same conductive layer as the second wiring 132a. The second connection wiring 152 is connected to the first connection wiring 144 via a contact hole formed in the first interlayer insulating layer 150.

A second interlayer insulating layer 154 is provided so as to cover the second wiring 132a and the second wiring 152. Further, a planarization layer 156 is provided so as to fill the step accompanying formation of the switching element 134. A level difference of the switching element 134 can be filled by providing the planarization layer 156, so that a surface of the planarization layer 156 becomes flat. Therefore, the patch electrode 108a can be formed on the flat surface (front surface) of the planarization layer 156 without being affected by the step of the switching element 134. A passivation layer 158 is arranged above the flat surface of the planarization layer 156. In the radio wave reflecting device 100a, the array layer 180 includes, for example, the undercoat layer 136, a conductive layer including the first gate electrode 138, the first gate insulating layer 140, the semiconductor layer 142, a conductive layer including the first connection wiring 144, the second gate insulating layer 146, a conductive layer including the second gate electrode 148, the first interlayer insulating layer 150, a conductive layer including the second connection wiring 152, the second interlayer insulating layer 154, the planarization layer 156, and the passivation layer 158. The array layer 180 may include a conductive layer that forms the patch electrode 108 provided in a contact hole that penetrates the passivation layer 158, the planarization layer 156, and the second interlayer insulating layer 154.

The patch electrode 108 is arranged above the passivation layer 158. The patch electrode 108 is connected to the second connection wiring 152 via the contact hole penetrating through the passivation layer 158, the planarization layer 156, and the second interlayer insulating layer 154. The first alignment film 112a is arranged above the patch electrode 108.

The ground electrode 110 and the second alignment film 112b are arranged on the opposing substrate 106, similar to the cross-section shown in FIG. 2 to FIG. 4. A surface of the dielectric substrate 104 on which the switching element 134 and the patch electrode 108a are arranged is provided so as to face a surface of the opposing substrate on which the ground electrode 110 is arranged, and the liquid crystal layer 114 is arranged between the surface on which the switching element 134 and the patch electrode 108a are provided and a surface on which the ground electrode 110 is provided. The thickness T of the dielectric substrate 104 may be a length from the surface of the patch electrode 108a on the liquid crystal layer 114 side to the surface of the dielectric substrate 104 on the other side than the surface on which the patch electrode 108 is provided. In this case, a thickness of at least one insulating layer (the undercoat layer 136, the first gate insulating layer 140, the second gate insulating layer 146, the first interlayer insulating layer 150, the second interlayer insulating layer 154, the planarization layer 156, and the passivation layer 158) between the patch electrode 108 and the dielectric substrate 104 can be taken into consideration.

Each layer formed on the dielectric substrate 104 is formed using the following materials. The undercoat layer 136 is formed of, for example, a silicon oxide film. The first gate insulating layer 140 and the second gate insulating layer 146 are formed of, for example, a silicon oxide film or a stacked structure of a silicon oxide film and a silicon nitride film. The semiconductor layer is formed of a silicon semiconductor such as amorphous silicon or polycrystalline silicon, or an oxide semiconductor including a metal oxide such as indium oxide, zinc oxide, or gallium oxide. The first gate electrode 138 and the second gate electrode 148 may be made of, for example, molybdenum (Mo), tungsten (W), or an alloy thereof. The first wiring 118, a second wiring 132 (for example, the second wiring 132a, the second wiring 132b), the first connection wiring 144, and the second connection wiring 152 are formed using a metallic material such as titanium (Ti), aluminum (Al), or molybdenum (Mo). For example, a stacked structure of titanium (Ti)/aluminum (Al)/titanium (Ti), or a stacked structure of molybdenum (Mo)/aluminum (Al)/molybdenum (Mo) may be employed. The planarization layer 156 is formed of a resin material such as acrylic or polyimide. The passivation layer 158 is formed of, for example, a silicon nitride film. The patch electrode 108a and the ground electrode 110 are formed of a metallic film such as aluminum (Al) or copper (Cu), or a transparent conductive film such as indium tin oxide (ITO).

As shown in FIG. 12, by connecting the second wiring 132a to a gate of the transistor used as the switching element 134, connecting the first wiring 118a to one of the source and the drain of the transistor, and connecting the patch electrode 108a to the other of the source and the drain, it is possible to apply a control signal by selecting a predetermined patch electrode from a plurality of patch electrodes 108a arranged in a matrix. Then, by providing the switching elements 134 in the individual patch electrodes 108a in the reflector 120, it is possible to apply a control voltage for each patch electrode 108a arranged in a row parallel to the direction X or for each patch electrode 108a arranged in a row parallel to the direction Y. For example, if the reflector 120 is upright, the reflection direction of the reflected wave can be controlled in the left-right direction and the up-down direction.

In the second sub-unit cell 103b, the patch electrode 108a, the first wiring 118a, and the second wiring 132a are replaced with the patch electrode 108b, the first wiring 118b, and the second wiring 132b.

### Second Embodiment

In a second embodiment, a radio wave reflecting device 100b capable of uniaxial reflection control will be described as an example. A reflection axis RY of the radio wave reflecting device 100b is uniaxial. In the radio wave reflecting device 100b, a reflection angle can be controlled with the reflection axis RY as a rotation axis. The radio wave reflecting device 100b according to the second embodiment does not include at least the array layer 180, the plurality of second wirings 132a, the plurality of second wirings 132b, and the second driving circuit 130 with respect to the radio wave reflecting device 100a according to the first embodiment. In the second embodiment, differences from the first embodiment will be mainly described.

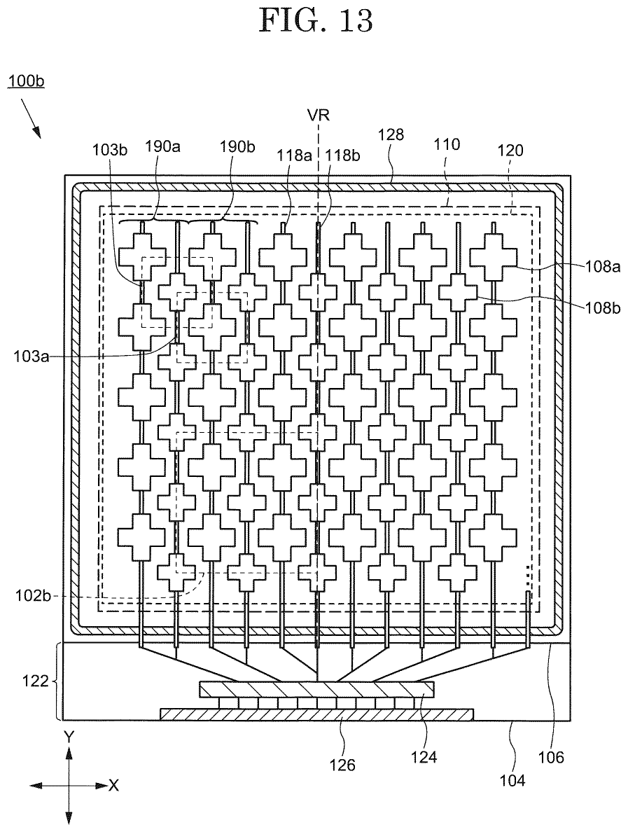

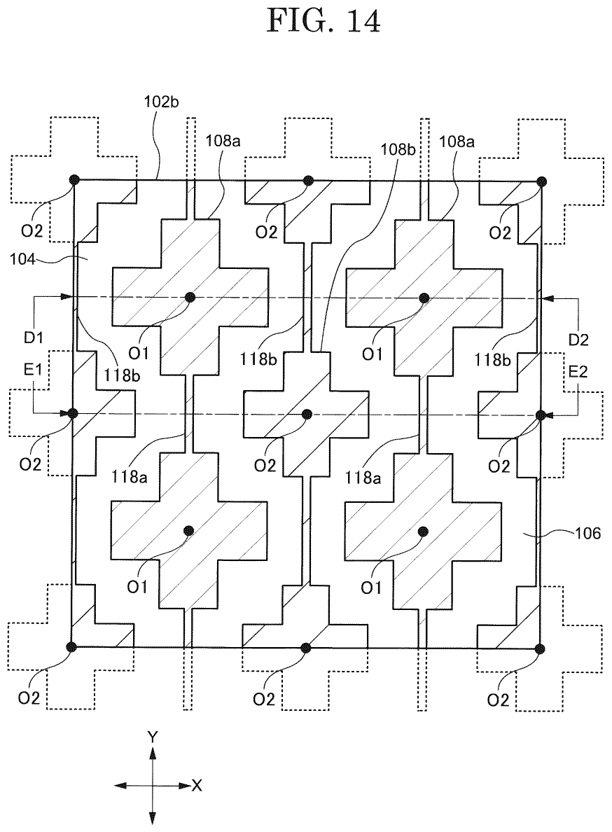

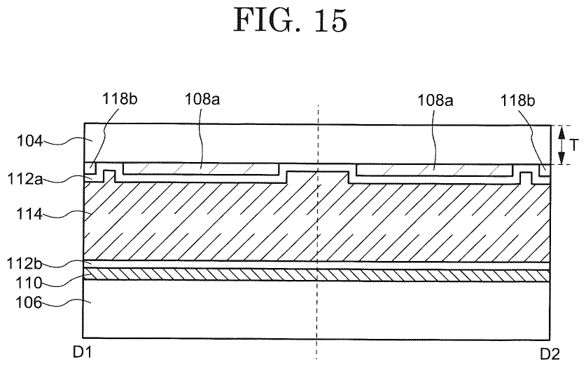

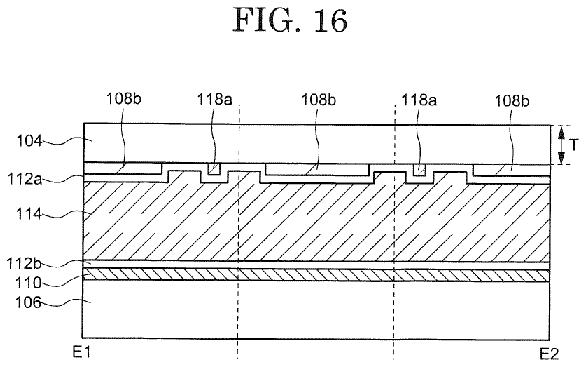

FIG. 13 is a plan view showing a configuration of the radio wave reflecting device 100b according to the second embodiment. FIG. 14 is a plan view showing a reflector unit cell 102b used in the radio wave reflecting device 100b. FIG. 15 is a cross-sectional view showing a cross-sectional surface of a line D1-D2 shown in FIG. 14, and FIG. 16 is a cross-sectional view showing a cross-sectional surface of a line E1-E2 shown in FIG. 14. Descriptions of the same or similar configurations as those in FIG. 1 to FIG. 12 will be omitted.

As shown in FIG. 13, the reflector 120 according to the second embodiment includes a plurality of reflector unit cells 102b. The reflector 120 according to the second embodiment includes a configuration in which the plurality of reflector unit cells 102 of the reflector 120 according to the first embodiment are replaced with the plurality of reflector unit cells 102b.

As shown in FIG. 13 and FIG. 14, the plurality of patch electrodes 108a arranged in the direction Y are electrically connected to the first wiring 118a, and the plurality of patch electrodes 108b arranged in the direction Y are electrically connected to the first wiring 118b. In the reflector 120 according to the second embodiment, a plurality of patch electrodes 108a electrically connected to the first wiring 118a and a plurality of patch electrodes 108b electrically connected to the first wiring 118b are set as a voltage application unit 190a, and a plurality of voltage application units 190a are arranged in the direction X. The first wiring 118a is electrically connected to the first wiring 118b in the peripheral region 122. In the reflector 120 according to the second embodiment, a voltage application unit 190b includes the same configuration as the voltage application unit 190a, and the voltage application units 190a and the voltage application units 190b are alternately arranged in the direction X. The first wiring 118a included in the voltage application unit 190a may be called a 1-1st wiring, the first wiring 118b included in the voltage application unit 190a may be called a 1-2nd wiring, the first wiring 118a included in the voltage application unit 190b may be called a 1-3rd wiring, and the first wiring 118b included in the voltage application unit 190b may be called a 1-4th wiring.

Similar to the reflector 120 described in “1. Reflector Unit Cell”, the reflector 120 according to the second embodiment is provided between the dielectric substrate 104 and the opposing substrate 106. As shown in FIG. 13 and FIG. 14, the reflector 120 according to the second embodiment has a configuration in which the plurality of reflector unit cell 102b are integrated. Similar to the reflector unit cell 102, the reflector unit cell 102b includes the first sub-unit cell 103a and the second sub-unit cell 103b.

As shown in FIG. 15 and FIG. 16, the first sub-unit cell 103a includes the ground electrode 110, the second alignment film 112b arranged above the ground electrode 110, the patch electrode 108a, the first alignment film 112a arranged above the patch electrode 108a, and the liquid crystal layer 114 arranged between the first alignment film 112a and the second alignment film 112b. The second sub-unit cell 103b includes the ground electrode 110, the second alignment film 112b arranged on the ground electrode 110, the patch electrode 108b, the first alignment film 112a arranged above the patch electrode 108b, and a liquid crystal layer (not shown) arranged between the first alignment film 112a and the second alignment film 112b. The patch electrodes 108a and 108b are arranged above the dielectric substrate 104, and the ground electrode 110 is arranged above the opposing substrate 106. The dielectric substrate 104 is bonded to the opposing substrate 106 using the sealing material 128. The liquid crystal layer is arranged in a region inside the sealing material 128.

In the reflector unit cell 102b, the patch electrodes 108a and 108b are arranged so as to face the incident surface of the radio wave. The ground electrode 110 has a flat plate shape. The plurality of patch electrodes 108a and 108b are arranged in a matrix in the plane of the flat ground electrode 110 and in the region inside the sealing material 128.

The plurality of first wirings 118a and 118b arranged on the reflector 120 according to the second embodiment extend to the peripheral region 122 and are connected to the first driving circuit 124. The first driver 124 outputs control signals to the patch electrodes 108a and 108b via the first wirings 118a and 118b. Consequently, in the reflector 120, control signals are applied to the patch electrodes 108a and the patch electrodes 108b arranged in the direction Y with respect to the patch electrodes 108a and the patch electrodes 108b arranged in the direction X and the direction Y.

In the radio wave reflecting device 100b, the first driving circuit 124 may apply a control signal to each voltage application unit 190a (voltage application unit 190b) arranged in the second direction. For each voltage application unit 190a (voltage application unit 190b) arranged in the second direction, the reflection direction of the reflected wave of the radio wave entering the reflector 120 can be controlled. That is, in the radio wave reflecting device 100a, the first driving circuit 124 can apply (supply) voltages (a first voltage and a second voltage) that differ between the voltage applying unit 190a and the voltage applying unit 190b, so that the direction of the reflected wave of the radio wave incident on the reflector 120 can be controlled in the left-right direction of the drawing around the reflecting axis VR parallel to the direction Y.

The plurality of patch electrodes 108a and 108b arranged in the second direction included in one voltage application unit 190a (voltage application unit 190b) are electrically connected to each other in the peripheral region 122 by using the first wirings 118a and 118b, and become electrically equipotential. In the radio wave reflecting device 100b, as shown in FIG. 13, the patch electrode 108a and the patch electrode 108b are arranged in an array as a shape symmetrical with respect to the vertically polarized wave and the horizontally polarized wave, and a plurality of patch electrodes 108a and a plurality of patch electrodes 108b arranged parallel to the reflection axis RY are connected by the first wiring 118a and the first wiring 118b, whereby the direction of the reflected wave of the radio wave incident on the reflector 120 can be controlled in the left-right direction of the drawing around the reflection axis VR parallel to the direction Y.

Various configurations of the radio wave reflecting device and the reflector unit exemplified as an embodiment of the present invention can be appropriately combined and implemented as long as no contradiction is caused. Furthermore, the addition, deletion, or design change of components, or the addition, deletion, or condition change of processes as appropriate by those skilled in the art based on the display panel integrated radio wave reflecting device disclosed in the specification and the drawings are also included in the scope of the present invention as long as they are provided with the gist of the present invention.

Further, it is understood that, even if the effect is different from those provided by each of the embodiments described above, the effect obvious from the description in the specification or easily predicted by persons ordinarily skilled in the art is apparently derived from the present invention.

What is claimed is:

1. An intelligent reflecting surface comprising:
a plurality of first patch electrodes;
a plurality of second patch electrodes having a size different from that of the plurality of first patch electrodes;
a ground electrode facing the plurality of first patch electrodes and the plurality of second patch electrodes and spaced apart from the plurality of first patch electrodes and the plurality of second patch electrodes; and
a liquid crystal layer arranged between the plurality of first patch electrodes and the plurality of second patch electrodes and the ground electrode, wherein
the plurality of first patch electrodes and the plurality of second patch electrodes are arranged in a matrix in a first direction and a second direction intersecting the first direction in a plan view, and
in the case where a distance between centers of two adjacent first patch electrodes is a distance W1, the second patch electrode is arranged at a position spaced apart from the first patch electrode by a distance W1/2 in parallel with the first direction and a distance W1/2 in parallel with the second direction, based on a position of the first patch electrode.

2. The intelligent reflecting surface according to claim 1, wherein
in a square formed by connecting centers of four second patch electrodes adjacent to one of the first patch electrodes among the plurality of first patch electrodes with a line,
an intersection of diagonal lines of the square coincides with a center of the one first patch electrode.

3. The intelligent reflecting surface according to claim 1, wherein
in a square formed by connecting centers of four first patch electrodes adjacent to one of the second patch electrodes among the plurality of second patch electrodes with a line,
an intersection of diagonal lines of the square coincides with a center of the one second patch electrode.

4. The intelligent reflecting surface according to claim 1, wherein
the size of the plurality of first patch electrodes is larger than the size of the plurality of second patch electrodes.

5. The intelligent reflecting surface according to claim 1, wherein
a shape of the plurality of first patch electrodes and a shape of the plurality of second patch electrodes are cross-shaped in a plan view.

6. The intelligent reflecting surface according to claim 1, wherein
the plurality of first patch electrodes and the plurality of second patch electrodes are arranged so as to be alternately positioned along the first direction and the second direction.

7. The intelligent reflecting surface according to claim 6, further comprising:
a first wiring electrically connected to at least two first patch electrodes among the plurality of first patch electrodes;
a second wiring electrically connected to at least two second patch electrodes among the plurality of second patch electrodes and arranged parallel to the first wiring; and
a driving circuit electrically connected to the first wiring and the second wiring,
wherein
the driving circuit is configured to supply a first voltage to the first wiring and the second wiring.

8. The intelligent reflecting surface according to claim 7, further comprising:
a third wiring electrically connected to at least two first patch electrodes different from the at least two first patch electrodes among the plurality of first patch electrodes and arranged parallel to the second wiring; and
a fourth wiring electrically connected to at least two second patch electrodes different from the at least two second patch electrodes among the plurality of second patch electrodes and arranged parallel to the third wiring, wherein
the third wiring and the fourth wiring are electrically connected to the driving circuit, and
the driving circuit is configured to supply a second voltage different from the first voltage to the third wiring and the fourth wiring.

9. The intelligent reflecting surface according to claim 1, wherein
each of the plurality of first patch electrodes and the plurality of second patch electrodes is electrically connected to a switching element.

10. The intelligent reflecting surface according to claim 1, wherein
the plurality of first patch electrodes and the plurality of second patch electrodes are configured to reflect radio wave frequencies corresponding to a 5G communication standard.
